(19) United States
(12) Patent Application Publication
(10) Pub. No.: US 2004/0120267 A1
(43) Pub. Date: Jun. 24, 2004

(54) Computer control system and user interface for remote media playing devices

(75) Inventor: Clifford Poindexter Howell, Baton Rouge, LA (US)

Correspondence Address: CLIFFORD P. HOWELL, 5946 GOODWOOD AVENUE, BATON ROUGE, LA, 70806, US

(73) Assignee: Clifford Poindexter Howell, Baton Rouge, LA (US)

(21) Appl. No.: 10/707,777

(22) Filed: Jan. 12, 2004

(51) Int. Cl. H04L 1/00

(52) U.S. Cl. 370/253

(57) ABSTRACT

A multi computer system and method for controlling, through a general network, a second computer to play media files. The system provides a user interface for allowing a user access to media pieces of audio files stored on the separate computer”s media database. The interface is for controlling the playback of audio file formats that is coupled to the second computer to play the accessed or selected piece of audio file. In one embodiment there is the first computer”s interface that allows a user to display only music that is located on the second computer that relates to song title or artist title. From the first computer, there is another embodiment allows the user to direct the second computer to automatically play selected music pieces that are decided by the first computer. Another embodiment displays on the first computer the time clock of the song playing on the second computer allowing a user to see the playing file”s time remain.

### CROSS REFERENCE TO RELATED APPLICATIONS

Examples of patents that are related to the present embodiment of the music medium are as follows, wherein each of the following patents are herein incorporated by reference for the supporting teachings: From U.S. Pat. No. 5,355,302, a network is known consisting of multiple jukeboxes, in which the individual jukeboxes are linked to a central management station in a star-shaped structure. The management station comprises a host computer and a mass storage device so that music data can be transmitted to the individual jukeboxes by the management station. In addition, the management station also takes over management jobs. For the servicing of the individual jukeboxes, a portable console is provided in each case which can be hooked up to the corresponding jukebox on site. U.S. Pat. No. 5,617,539, for “Multimedia collaboration system with separate data network and A/V network controlled by information transmitting on the data network,” to Ludwig et al., granted Apr. 1, 1997, describes a system that integrates real-time and asynchronous networks. This system, however, does not address the wired/wireless synchronization issue, nor does it address the multi-hop wireless synchronization issue. U.S. Pat. No. 5,623,483, for “Synchronization System for Networked Multimedia Streams,” to Agrawal et al., granted Apr. 22, 1997, discusses multi-stream multimedia content which is played on different output devices and how, with the use of buffers, two disparate multimedia streams may be synchronized to each other. U.S. Pat. No. 5,689,641, for “Multimedia collaboration system arrangement for routing compressed AV signal through a participant site without decompressing the AV signal,” to Ludwig et al., granted Nov. 18, 1997, further describes the system of U.S. Pat. No. 5,617,539. U.S. Pat. No. 5,790,792, for “Method and apparatus for transmitting multimedia from an application logic server to interactive multimedia workstations,” to Dudgeon et al., granted Aug. 4, 1998, describes a network wherein a server handles all processing of real-time graphical images, however, this reference does not consider synchronization or wireless issues. U.S. Pat. No. 5,754,241, for “Video decoder capable of controlling encoded video dat,” to Okada et al., granted May 19, 1998, describes an MPEG decoder having an over-flow proof buffer. U.S. Pat. No. 5,754,961, for “Radio communication system including SDL having transmission rate of relatively high speed,” to Serizawa et al., granted May 19, 1998, describes a system having both high and low speed transmission/reception capabilities. U.S. Pat. No. 5,757,857, for “High speed self-adjusting clock recovery circuit with frequency detection,” to Buchwald, granted May 26, 1998, describes a circuit wherein all transmission is done without any systemic phase offset. U.S. Pat. No. 5,758,079, for “Call control in video conferencing allowing acceptance and identification of participants in a new incoming call during an active teleconference,” to Ludwig et al., granted May 26, 1998, is related to U.S. Pat. No. 5,689,641, discussed above. This reference continues the discussion of synchronization of real-time and asynchronous networks, but still fails to address the issue of wired/wireless packet data synchronization. U.S. Pat. No. 5,768,321, for “Automatic frequency control unit which detects a frame pattern in a phase modulation signal,” to Watanabe et al., granted Jun. 16, 1998, describes the transmission of a multimedia signal by a satellite communications system.

### BACKGROUND OF INVENTION

1. Field of the Invention

The present invention generally relates to a multi computer system and user interface for allowing a user access to a selection of media pieces stored on a second computer”s media database and for directing and controlling a media playing device to play the selected media piece from a second computer.

2. Description of the Prior Art

There are many media mediums that have been developed in the last few decades. For example, there are several music mediums, like records, tapes, or CDs. Today”s music is of the digital medium, allowing the streaming of audio playback through a network. For the purpose of this disclosure and illustration of an embodiment of the invention, the music media and a media playing device such as a computer will be focused upon.

The advent of the modern computer is a tremendous breakthrough in the music world. Whether someone was relaxing at home or entertaining a houseful of guests, a computer would give someone the best of both worlds—a fine acoustic instrument for audio playback and a way to enjoy the same vibrant sounds automatically by using large play lists. Even Hotels, restaurants, clubs and other establishments play music on call at all hours of the day or night, using large play lists. Those who are familiar with computers of old would not have enjoyed music playback, being equipped with an archic sound card filled with hissing. The old music technology for computers and there audio, have been replaced by faster processors and smoother analog playback technology. Computers can now playback music with such preciseness that all but the most accomplished music listeners can be fooled when comparing a CD player to a computer”s audio playback.

There are more computer networks at home giving demand for streaming a song from one computer to another. Through a network, the user can click on a song that is located on a second computer and in seconds the music is playing on the users computer”s multimedia speakers.

### SUMMARY OF INVENTION

It is a feature of the invention to provide the first computer”s user interface. The interface is for providing a user access to media pieces stored on a second computer. The interface is also for controlling a second computer”s media playing device, that is coupled to the computer to play the accesses or selected piece of media. It is another feature of the invention to provide the first computer”s interface that allows a user to display only music that relates to a selected category, like song title or artist title. Where the user is then able to direct the second computer”s media playing device to automatically play the selected music pieces related to the selected music categories from the first computer. A further feature of the invention is to provide the first computer”s interface that allows a user to display music selections that are related to song title or artist tittle. Where the user is then able to direct the second computer”s media playing device to automatically play the selected music pieces related to the selected music composer from the first computer. A feature of the invention is also to provide a multi computer system that can access others media data bases from other sources like internet or world wide web. Yet a further feature of the invention is to provide a computer system that can access all types of audio media, from any multimedia data base source. It is a further feature of the invention to provide a system for playing media information and implementing a computer as a control means. There is included therein a media playing means for playing media information for a user. Additionally, the control means is coupled to the media playing means. The control means is for allowing a user to automatically control the media playing means in playing the media information. The control means has a display means for displaying the second computer”s music information to the user. The control means further has a data storage means for storing and for enabling data used for enabling the control means to control the media playing means in playing a selected item. Additionally, the control means has a user interface means, displayed on the display means, for displaying to the user multimedia song information. The invention resides not in any one of these features per se, but rather in the particular combination of all of them herein disclosed and claimed and it is distinguished from the prior art in this particular combination of all of its structures for the functions specified. There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, neither is it intended to be limiting as to the scope of the invention in any way. Other features of the present invention will become more clear from the following detailed description of the invention, taken in conjunction with the accompanying drawings and claims, or may be learned by the practice of the invention.

### DETAILED DESCRIPTION

The first embodiment relates to the use of a multi computer system and user interface to control which music is to be played upon a second computer. Although one skilled in the art will know how streaming music works and how a computer controlled play list works, these two topics are provided for background purposes. A second embodiment of the invention relates to the use of a computer system and user interface for allowing a user to select which movie video will be played upon a computer controlled video media playing device or the like. One skilled in the art of computers and video control will understand how the system operates in view of the discussion of the player piano operation. First Computer”s Interface For A User To Control the Audio Operation of A Second Computer The user”s interface computer screen that may be used to access the music database and control the second computer”s audio playback is typically a tube or LCD computer monitor. It is noted that references to the phrase “data field” is meant to mean a listing of items relating to song title or artist title of the music files found on the hard drive of the second computer. For example, the illustrated “Artist Title” category can list in the data field all of the composers found in the music data base, like Liszt, Debussy, Gershwin, Mendelssohn, etc. It is pointed out that term of “selecting” means that a pointer or cursor, is placed over the desired item while the user usually clicks a mouse button clicks with there finger on a touch screen. The pointer is also known as a selection means. It is also noted that the word “item” is meant to mean a single piece of a music file found in the data field related to a selected category. For example, “Let It Be” is an item found in the data field related to the category of song title”s Category (labeled as Category for short), or “Beatles” is an item found in the data field related to the category of “Artist Titles.” Operation of Data Fields It is pointed out that “displaying a data field” is automatically accomplished by the player piano control system and the relevant software control. Displaying of data is accomplished after a selection of an item is made. First, once a user has selected an item with the mouse, the CPU interprets the coding sent from the mouse and determines which item has been selected and thus highlights the selected item on the display. Second, the player piano control system eliminates the current list or lists of items found in the remaining relevant data fields. Third, the control system will search for all data related to the selected item. Forth, the control system receives signals from the various data storage devices and uses this information to direct the display to display those identified items that will be related to the selected item in the proper data fields. The data field labeled as “Composer,” as the title indicates, can display all of the original composers of each piece of music found in the data. For example, the items of Albeniz, Albinoni, Archer, and Armstrong etc. are illustrated in FIG. 2. This data field also allows the user to control what may be displayed in the other data fields in the same fashion as the music “Category” operation. For example, regarding FIG. 3, by selecting Beethoven as shown, all of the other data fields may be directed to only display data found in the data base that pertains to the composer Beethoven. The user may now display only items in the Artist and Selected Songs categories that are related to Beethoven. By providing a user with these features, hundreds or thousands of items are eliminated from being displayed on the user display, thereby allowing the user to more easily make selections of music to be played upon the player piano. Operation of Play Button On the first computer there is a visible play button of any shape or size. The operation of this button works much like a typical CD player. The button is typically known to one skilled in the art as the “play” button. When the play button is actuated, the second computer is instructed to play to its own audio output. The player piano will begin to play the selected music piece as indicated by the first computer. Another button on the first computer”s interface of any shape or size called Pause. This button allows the user to temporarily suspend the playing of a song on the second computer. Upon activating the pause button again or by reactuation of the play button, the second computer will start playback at the exact spot that it had been stopped There are additional features provided by the Song List screen or window. For instance, the user could select the “Open Song List” button to get a list of all previously created song lists. The user could either edit individual song lists by eliminating or adding individual songs or play selected song lists. When a user wishes to create a new song list from scratch, the “Clear Song List” button would be selected, which would clear the screen of any listed song titles. The feature of creating your own music lists allows the every-day computer user to create their own music albums or collections and not be limited to where the songs are stored. For example, the user can now control, from the kitchen computer, musical events like a list of children's birthday party music, teenager party music, young couples wedding music, or old couples anniversary music which are stored and played from the computer located in a home theatre closet. It is even possible for a restaurant to program music for an entire evening beginning with lively after work music for happy hour and gradually changing the song selections to be quieter for the dinner crowd controlled from a wireless laptop in the parking lot.

1. A computer user interface selection process for allowing the user to select audio files to be played on the first computer controlled by a second computer connected through a general network, comprising the steps of:
a) an interface apparatus, wherein an input device and an output device are integrated in the first computer.
b) an interface apparatus, wherein an input device and an output device are integrated in the second computer.
c) displaying on the second computer on a display device, song titles or artist titles of the first computer”s multimedia music files in data fields; d) selecting on the second computer from one or more of the data fields of the first computer”s music files, containing song, and artist titles.

2. The process of claim 1, wherein the step of playing the selected song item comprises: a) activating a play action on the first computer from the second computer; b) sending data through a general network from the second computer to the first computer containing specific song title and artist title, in response to step a) for controlling the first computer”s song playback of the selected song controlled by the second computer; c) receiving a data through a general network from the first computer to the second computer containing song title, artist title and playback time information in response to step a) for displaying on the second computer with the first computer”s song that is being played with the song title, artist title, and sycronized playback time countdown information.

9. The methods of claim 2, wherein the step of playing, further comprises: b) selecting on the second computer, by the user, a pause play button that will temporarily suspend the song playback on the first computer; c) selecting on the second computer, by the user, the pause play button a second time to enable the song playback on the first computer.

10. The method of claim 9, wherein the step of playing, further comprises: d) selecting, on the second computer, by the user, a stop play button that will disable the song playback on the first computer.

11. A system for playing media information on a media playing means, the system comprising: a) the media playing means for playing the media information for a user where the playing means is capable of playing musical sound; and b) control means, coupled to the media playing means, for allowing the user to remotely select media information and to automatically control the media playing means in playing the selected media information through a general network, the control means having: b1) data storage means for storing the media information on the first computer, the media information including audio file formats, like WMA, MP3, WAV, AU, AAC, or OGG
1) a first data field of media information containing song titles of items found on the first computer in the data storage means that are related to the first data field, and 2) a second data field of media information containing artist titles of items found on the first computer in the data storage means that are related to the second data field; b2) display means for visually displaying on the second computer the first or second data fields of media information contained on the first computer so the user may control the playback of songs located on the first computer remotely from the second computer.

20. A machine readable media containing instructions for causing multiple computers to perform the operation of connecting each other involved in a wired or wireless network which transmits multimedia information including song title, artist title, and song playback time through the network, wherein the operation comprises:
a computer user interface process on the second computer allows the user to view audio files to be played on the first computer by song title and artist title.

23. A machine readable media containing instructions for causing two computers to perform the operation of connecting each other involved in a wired or wireless network to transmit instructions from one computer to another computer to play certain audio files on its own playback device, wherein the operation comprises:
a machine readable media according to claim 23, wherein the computer playing an audio file to its own playback device transmits scronized time countdown of the song playing to the other computer, and
a machine readable media according to claim 23, wherein a computer displays the received scronized time countdown of the song playing on a second computer.

24. A machine readable media containing instructions for causing multiple computers to perform the operation of connecting each other involved in a wired or wireless network allowing a user, from the second computer, to start the playback of songs located on the first computer to its own audio device wherein the operation comprises:
a machine readable media according to claim 24, wherein one computer having large capacity contains multimedia music files receives playback instructions from another computer as to when to play certain audio files and,
a machine readable media according to claim 24, wherein one computer having small capacity transmits playback instructions to another computer as to when to play certain audio files.

18. The system of claim 17, wherein the storage means is a hard disk drive for a computer.

19. The system of claim 18, wherein the data storage means is located remote to the display means and media playing means.

20. The system of claim 19, wherein the display means is a computer monitor.
